(19) United States
(12) Patent Application Publication
(10) Pub. No.: US 2024/0216808 A1
(43) Pub. Date: Jul. 4, 2024

(54) MAP DISPLAY CONTROL METHOD AND APPARATUS, DEVICE, AND MEDIUM

(71) Applicant: NETEASE (HANGZHOU) NETWORK CO., LTD., Hangzhou, Zhejiang (CN)

(72) Inventor: Huaying HUANG, Hangzhou, Zhejiang (CN)

(73) Assignee: NETEASE (HANGZHOU) NETWORK CO., LTD., Hangzhou, Zhejiang (CN)

(21) Appl. No.: 18/555,876

(22) PCT Filed: Nov. 2, 2021
(86) PCT No.: PCT/CN2021/128270

§ 371 Date: Oct. 18, 2023

(30) Foreign Application Priority Data
Apr. 21, 2021 (CN) 202110430462.7

(51) Int. Cl. A63F 13/5378; G06T 3/40; G06T 7/70

(52) U.S. Cl. CPC A63F 13/5378; G06T 3/40; G06T 7/70; G06T 2200/24

(57) ABSTRACT

A map display control method, applied to the technical field of computers. The method comprises: in response to a map amplification instruction on a first-level map, increasing a first scale of the first-level map, and displaying the first-level map according to the first scale; and in response to the first scale being greater than or equal to a first threshold determining a target position in the first-level map according to the map amplification instruction, and displaying a second-level map corresponding to the target position.

This disclosure is a U.S. National Stage of International Application No. PCT/CN2021/128270, filed on Nov. 2, 2021, which claims priority to Chinese patent application No. 202110430462.7, entitled “MAP DISPLAY CONTROL METHOD AND APPARATUS, DEVICE, AND MEDIUM”, filed on Apr. 21, 2021, the entire contents of which are incorporated by reference in their entirety.

### TECHNICAL FIELD

The present disclosure relates to the field of computer technology, and in particular to a map display control method and apparatus, device, and medium.

### BACKGROUND

With the development of gaming applications, most games deploy multi-level maps and maps of the upper and lower levels can be switched.

Currently, players usually trigger map switching by clicking on the switch button displayed on the current map interface. This interactive operation of map display control will have a fault when the map is switched, thus affecting game experience of the player.

### SUMMARY

Embodiments of the present disclosure provide the following technical solutions.

On the one hand, embodiments of the present disclosure provide a map display control method, including:
increasing a first scale of a first-level map in response to a map enlargement instruction for the first-level map, and displaying the first-level map according to the first scale; and
determining a target position in the first-level map according to the map enlargement instruction in response to the first scale being greater than or equal to a first threshold, and displaying a second-level map corresponding to the target position.

In one possible implementation, the first-level map is a map corresponding to a first region, the second-level map is a map corresponding to a second region, the first region includes the second region, and the second region includes the target position.

In one possible implementation, displaying the second-level map corresponding to the target position includes:
displaying the second-level map corresponding to the target position in a second initial scale.

In one possible implementation, the second initial scale is greater than or equal to a maximum scale of the first-level map.

In one possible implementation, the target position is a focus position of the map enlargement instruction, or the target position is a position within a set range of the focus position of the map enlargement instruction that satisfies a condition.

In one possible implementation, the first-level map and the second-level map are two preset maps.

In one possible implementation, the map display control method provided by an embodiment of the present disclosure further includes:
reducing a second scale of the second-level map in response to a map reduction instruction for the second-level map, and displaying the second-level map according to the second scale;
displaying the first-level map in response to the second scale being less than or equal to a second threshold.

In one possible implementation, the map enlargement instruction is a two-finger open operation acting on the first-level map, and the map reduction instruction is a two-finger pinch operation acting on the second-level map.

In one possible implementation, displaying the first-level map includes:
displaying the first-level map in a first initial scale.

In one possible implementation, the first initial scale is less than or equal to a minimum scale of the second-level map.

On the other hand, embodiments of the present disclosure provide a map display control apparatus, including:
a first response unit, configured to increase a first scale of a first-level map in response to a map enlargement instruction for the first-level map, and display the first-level map according to the first scale; and
a second response unit, configured to determine a target position in the first-level map according to the map enlargement instruction in response to the first scale being greater than or equal to a first threshold, and display a second-level map corresponding to the target position.

In one possible implementation, the first-level map is a map corresponding to a first region, the second-level map is a map corresponding to a second region, the first region includes the second region, and the second region includes the target position.

In one possible implementation, when the second-level map corresponding to the target position is displayed, the second response unit is specifically configured to:
display the second-level map corresponding to the target position in a second initial scale.

In one possible implementation, the second initial scale is greater than or equal to a maximum scale of the first-level map.

In one possible implementation, the target position is a focus position of the map enlargement instruction, or the target position is a position within a set range of the focus position of the map enlargement instruction that satisfies a condition.

In one possible implementation, the first-level map and the second-level map are two preset maps.

In one possible implementation, the map display control apparatus provided by an embodiment of the present disclosure further includes:
a third response unit, configured to reduce a second scale of the second-level map in response to a map reduction instruction for the second-level map, and display the second-level map according to the second scale;
a fourth response unit, configured to display the first-level map in response to the second scale being less than or equal to a second threshold.

In one possible implementation, the map enlargement instruction is a two-finger open operation acting on the first-level map, and the map reduction instruction is a two-finger pinch operation acting on the second-level map.

In one possible implementation, when the first-level map is displayed, the fourth response unit is specifically configured to:
display the first-level map in a first initial scale.

In one possible implementation, the first initial scale is less than or equal to a minimum scale of the second-level map.

On the other hand, embodiments of the present disclosure provide terminal device, including: a memory, a processor and computer programs stored on the memory and executable on the processor, wherein the processor implements the map display control method provided by embodiments of the present disclosure when executing the computer programs.

On the other hand, embodiments of the present disclosure provide a non-transitory computer readable storage medium, having computer instructions stored thereon, wherein the computer instructions implement the map display control method provided by embodiments of the present disclosure when executed by a processor.

### BRIEF DESCRIPTION OF THE DRAWINGS

The accompanying drawings illustrated herein are used to provide a further understanding of the present disclosure and form part of the present disclosure, and the schematic embodiments of the present disclosure and their descriptions are used to explain the present disclosure and do not constitute an undue limitation of the present disclosure. In the accompanying drawings:

FIG. 1 a schematic diagram of conventional interactive operation of a map display control method in an embodiment of the present disclosure;

FIG. 2a a schematic diagram of an overview flow of a map display control method for switching from a first-level map to a second-level map in an embodiment of the present disclosure;

FIG. 2b a schematic diagram of enlarging a first-level map by a two-finger open operation in the embodiment of the present disclosure;

FIG. 2c a schematic diagram of enlarging a first-level map by means of a scale adjustment control in the embodiment of the present disclosure;

FIG. 2d is a schematic view of performing a two-finger open operation with position A as the focus in the embodiment of the present disclosure;

FIG. 2e is a schematic view of performing a two-finger open operation in the vicinity of position A in the embodiment of the present disclosure;

FIG. 2f is a schematic diagram of performing a click operation on a scale adjustment control displayed in the vicinity of position A in the embodiment of the present disclosure;

FIG. 2g a schematic diagram of performing a click operation on a scale adjustment control after performing a select operation on position A in a first-level map in an embodiment of the present disclosure;

FIG. 3a is an overview flow schematic diagram of a map display control method for switching back to a first-level map from a second-level map provided in an embodiment of the present disclosure;

FIG. 3b is a schematic diagram of reducing a second-level map by a two-finger pinch operation in an embodiment of the present disclosure;

FIG. 3c is a schematic diagram of reducing a second-level map by means of a scale adjustment control in an embodiment of the present disclosure;

FIG. 4a is a schematic diagram of a specific process of a map display control method in an embodiment of the present disclosure;

FIG. 4b is a schematic diagram of a specific flow of a map display control method in another embodiment of the present disclosure;

FIG. 5 is a schematic diagram of the functional structure of a map display control apparatus in an embodiment of the present disclosure; and

FIG. 6 is a hardware structural schematic diagram of the terminal device in an embodiment of the present disclosure.

### DETAILED DESCRIPTION

In order to make the purpose, technical solutions and beneficial effects of the present disclosure more clear, the technical solutions in the embodiments of the present disclosure will be clearly and completely described below in conjunction with the accompanying drawings in the embodiments of the present disclosure. It is clear that the described embodiments are only a part of the embodiments of the present disclosure, and not all of the embodiments. Based on the embodiments in the present disclosure, all other embodiments obtained by a person of ordinary skill in the art without creative labor fall within the scope of protection of the present disclosure.

In order to facilitate better understanding of the present disclosure by a person of ordinary skill in the art, the technical terms involved in the present disclosure are briefly introduced first in the following.

1. A map is a graph or image that depicts relationships such as spatial distribution, geographical position or the like between various regions and various things in various regions in a game on a plane in a two-dimensional or multi-dimensional form. In this disclosure, the map includes a first-level map and a second-level map.

The first-level map is a map corresponding to the first region.

The second-level map is a map corresponding to the second region.

In the present disclosure, the first region includes a second region, and the first-level map and the second-level map are two preset maps. For example, the first region may be the world in the game, and the second region may be a region containing at least one city in the world, then the first-level map may be a preset world map, and the second-level map may be a preset city map containing at least one city, etc.

2. A scale is a numerical value characterizing the degree of scaling of the map. In the present disclosure, the scale includes a first scale, a second scale, a maximum scale, a minimum scale, a first initial scale and a second initial scale.

The first scale is the scale corresponding to the first-level map.

The second scale is the scale corresponding to the second-level map.

The maximum scale is the scale at which the first-level map is enlarged to its maximum.

The minimum scale is the scale at which the second-level map is reduced to its minimum.

The first initial scale is the initial scale of the first-level map when switching from the second-level map to the first-level map.

The second initial scale is the initial scale of the second-level map when switching from the first-level map to the second-level map.

It should be noted that references to “first”, “second”, etc. in this disclosure are used to distinguish between similar objects and need not be used to describe a particular order or sequence. It should be understood that such terms are interchangeable where appropriate, so that the embodiments described herein can be implemented in an order other than that illustrated or described herein.

Having introduced the technical terms involved in the present disclosure, the application scenarios and design ideas for embodiments of the present disclosure are briefly described in the following.

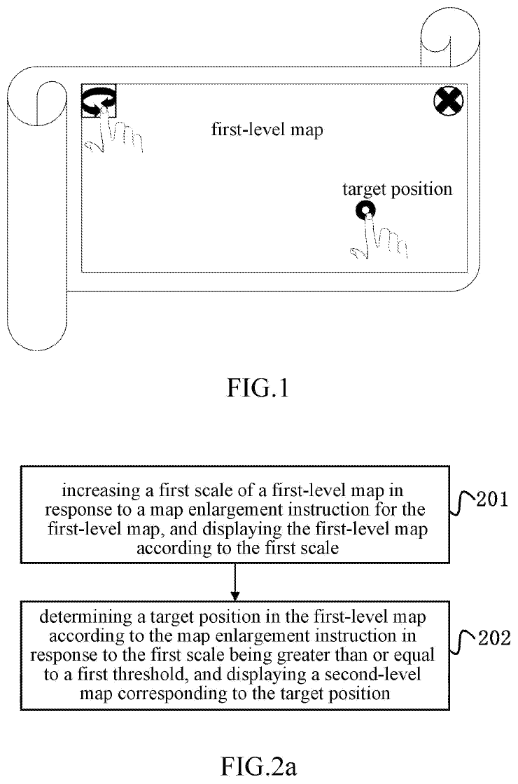

Currently, referring to FIG. 1, in most game applications, a player usually clicks on a target position on a first-level map and then switches to the second-level map corresponding to that target position by clicking on a switch button displayed on the first-level map. This interactive operation of map display control will have a fault when the map is switched for display, thus affecting game experience of the player.

For this reason, in this embodiment of the present disclosure, the player can enlarge the first-level map by using the map enlargement instruction until the first scale of the first-level map is not less than the first threshold, and then switch to the second-level map corresponding to the target position indicated by the map enlargement instruction, thus achieving seamless switching between the first-level map and the second-level map during the process of enlarging and displaying the first-level map, which is simple and smooth, thus providing the player with a better gaming experience.

Having introduced the application scenarios and design ideas of the embodiments of the present disclosure, the technical solutions provided by the embodiments of the present disclosure are described in detail below.

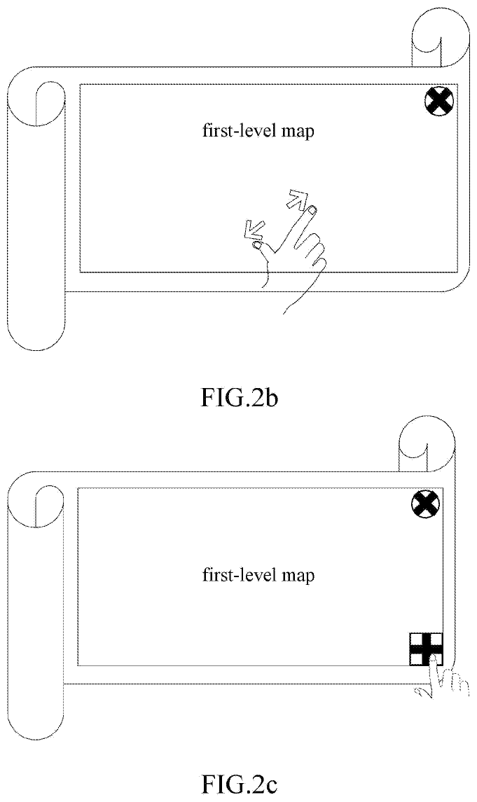

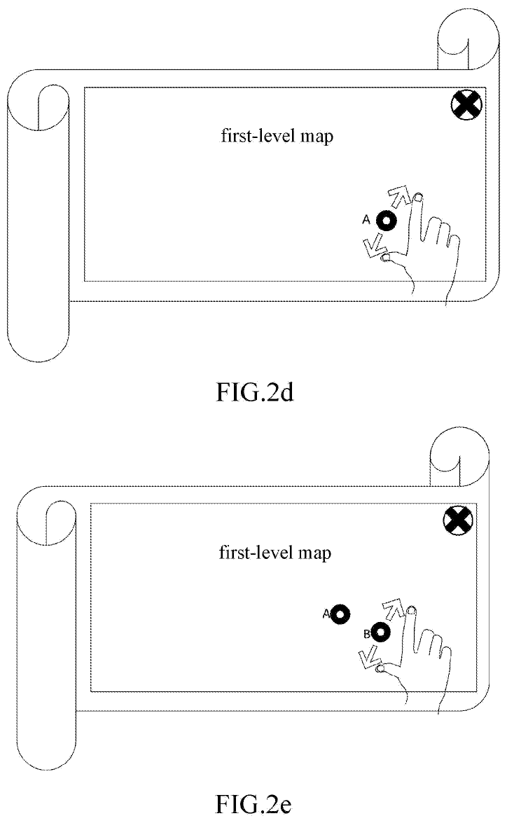

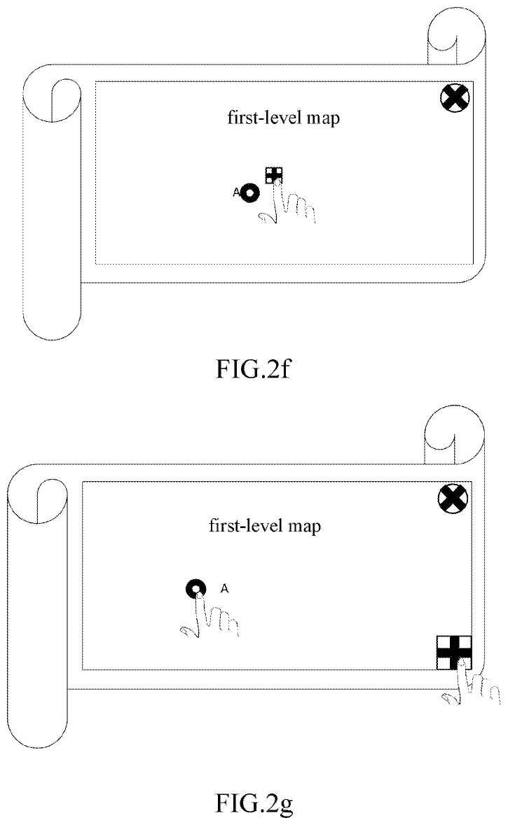

The embodiment of the present disclosure provides a map display control method. The map display control method can be applied to a terminal device installed with a gaming application. Referring to FIG. 2a, the map display control method provided by the embodiment of the present disclosure includes following steps.

Step 201, a first scale of a first-level map is increased in response to a map enlargement instruction for the first-level map, and the first-level map is displayed according to the first scale.

In one embodiment, referring to FIG. 2b, the player may enlarge the first-level map by performing a two-finger open operation on the first-level map to view the first-level map. That is, the map enlargement instruction may be a two-finger open operation acting on the first-level map. Specifically, the terminal device, in response to the two-finger open operation acting on the first-level map, determines a first two-finger spacing corresponding to the two-finger open operation, and determines the first scale adjustment step corresponding to the first two-finger spacing according to the correspondence between the two-finger spacing and the scale adjustment step, and displays the first-level map according to the first scale after increasing the first scale of the first-level map according to the first scale adjustment step.

In another embodiment, referring to FIG. 2c, the player may also enlarge the first-level map by performing a click operation on the scale adjustment control to view the first-level map. That is, the map enlargement instruction may also be a click operation acting on the scale adjustment control. Specifically, the terminal device, in response to the click operation acting on the scale adjustment control, determines the default scale adjustment step corresponding to the click operation, and displays the first-level map according to the first scale after increasing the first scale of the first-level map according to the default scale adjustment step.

Step 202, a target position is determined in the first-level map according to the map enlargement instruction in response to the first scale being greater than or equal to a first threshold, and a second-level map corresponding to the target position is displayed.

Correspondingly, in one embodiment, the player may enlarge the first-level map by performing a two-finger open operation on the first-level map to view the first-level map, until the first scale of the first-level map is greater than or equal to the first threshold. At this time, the terminal device, in response to that the first scale of the first-level map is greater than or equal to the first threshold, may determine the target position in the first-level map based on the two-finger open operation acting on the first-level map, and display the second-level map corresponding to the target position.

Optionally, the terminal device may determine the target position in the first-level map based on the two-finger open operation acting on the first-level map in the following manners, but not limited thereto.

In a first manner, the terminal device may determine the focus position of the two-finger open operation as the target position. The focus position may be the center position of the map scaling, for example, which may be the midpoint position of the two finger touch points. For example, referring to FIG. 2d, when the player performs a two-finger open operation with position A as the focus position, the terminal device may determine the focus position of the two-finger open operation as the target position. Further, the terminal device may display a second-level map corresponding to the target position.

In a second manner, the terminal device may determine a position within a set range of the focus position of the two-finger open operation that satisfies a condition as a target position. For example, referring to FIG. 2e, when the player performs a two-finger open operation near position A, the terminal device may identify a position A within a set range centered on the focus position B of the two-finger open operation that has a distance less than or equal to a set threshold from the focus position B as a target position. Further, the terminal device may display a second-level map corresponding to the target position.

In another embodiment, the player may enlarge the first-level map by performing a click operation on the scale adjustment control to view the first-level map until the first scale of the first-level map is greater than or equal to the first threshold. At this time, the terminal device, in response to that the first scale of the first-level map is greater than or equal to the first threshold, may determine the target position in the first-level map based on the click operation acting on the scale adjustment control, and display the second-level map corresponding to the target position.

Optionally, the terminal device may determine the target position in the first-level map based on the click operation acting on the scale adjustment control in the following manners, but not limited thereto.

In the first manner, the terminal device may determine the target position based on the position where the click operation is performed. For example, referring to FIG. 2f, when a player performs a click operation on a scale adjustment control displayed in the vicinity of position A, the terminal device may determine position A within a set range of the execution position B of the click operation that has a distance less than or equal to a set threshold from the execution position B of the click operation as a target position. Further, the terminal device may display a second-level map corresponding to the target position.

In a second manner, the terminal device may determine the target position based on the selection operation acting on the first-level map prior to the click operation. For example, referring to FIG. 2g, when a player performs a click operation on a scale adjustment control after performing a selection operation on position A in the first-level map, the terminal device may determine the position A corresponding to the selection operation as the target position. Further, the terminal device may display the second-level map corresponding to the target position.

In embodiments of the present disclosure, in order to achieve seamless switching from the first-level map to the second-level map, the terminal device may display the second-level map corresponding to the target position in a second initial scale when displaying the second-level map corresponding to the target position. The second initial scale is greater than or equal to the maximum scale of the first-level map.

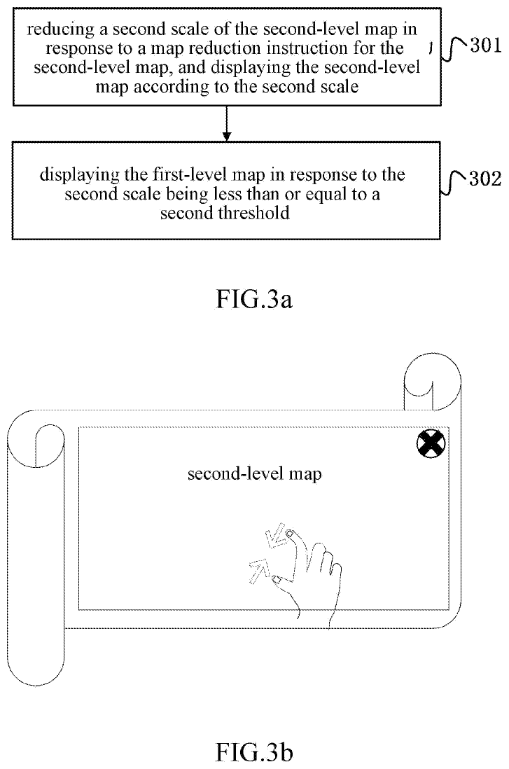

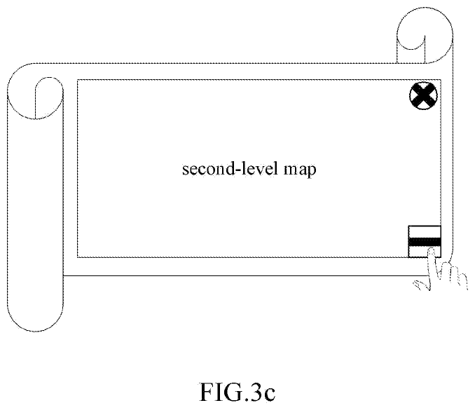

Further, in embodiments of the present disclosure, after switching from the first-level map to the second-level map via the map enlargement instruction, it may also switch back to the first-level map from the second-level map via the map reduction instruction. Specifically, referring to FIG. 3a, the game map switching method provided in embodiments of the present disclosure further includes following steps.

Step 301, a second scale of the second-level map is reduced in response to a map reduction instruction for the second-level map, and the second-level map is displayed according to the second scale.

In one embodiment, referring to FIG. 3b, the player may reduce the second-level map by performing a two-finger pinch operation on the second-level map to view the second-level map. That is, the map reduction instruction may be a two-finger pinch operation acting on the second-level map. Specifically, the terminal device, in response to the two-finger pinch operation acting on the second-level map, determines a second two-finger spacing corresponding to the two-finger pinch operation, and determines the second scale adjustment step corresponding to the second two-finger spacing according to the correspondence between the two-finger spacing and the scale adjustment step, and displays the second-level map according to the second scale after the second scale of the second-level map is reduced according to the second scale adjustment step.

In another embodiment, referring to FIG. 3c, the player may also reduce the second-level map by performing a click operation on the scale adjustment control to view the second-level map. That is, the map reduction instruction may also be a click operation acting on the scale adjustment control. Specifically, the terminal device, in response to the click operation acting on the scale adjustment control, determines the default scale adjustment step corresponding to the click operation, and displays the second-level map according to the second scale after reducing the second scale of the second-level map based on the default scale adjustment step.

Step 302, the first-level map is displayed in response to the second scale being less than or equal to a second threshold.

Correspondingly, in one embodiment, the player may reduce the second-level map by performing a two-finger pinch operation on the second-level map to view the second-level map until the second scale of the second-level map is less than or equal to the second threshold. At this time, the terminal device may display the first-level map in response to the second scale of the second-level map being less than or equal to the second threshold.

In another embodiment, the player may reduce the second-level map by performing a click operation on the scale adjustment control to view the second-level map until the second scale of the second-level map is less than or equal to the second threshold. At this time, the terminal device may display the first-level map in response to that the second scale of the second-level map is less than or equal to the second threshold.

In this embodiment of the disclosure, in order to achieve seamless switching from the second-level map to the first-level map, the terminal device may display the first-level map in a first initial scale when displaying the first-level map. The first initial scale is less than or equal to the minimum scale of the second-level map.

Most Massively Multiplayer Online (MMO) games deploy a world map and a city map, and switching between the world map and the city map is usually triggered by a switching button, which can cause a fault in switching between the world map and the city map. For this reason, the map display control method provided by the embodiments of the present disclosure can be used to achieve seamless switching between the world map and the city map in MMO games.

The following is a further detailed description of the map display control method provided by embodiments of the present disclosure, using “the first-level map is a world map in an MMO game, and the second-level map is a city map in an MMO game” as an example application scenario.

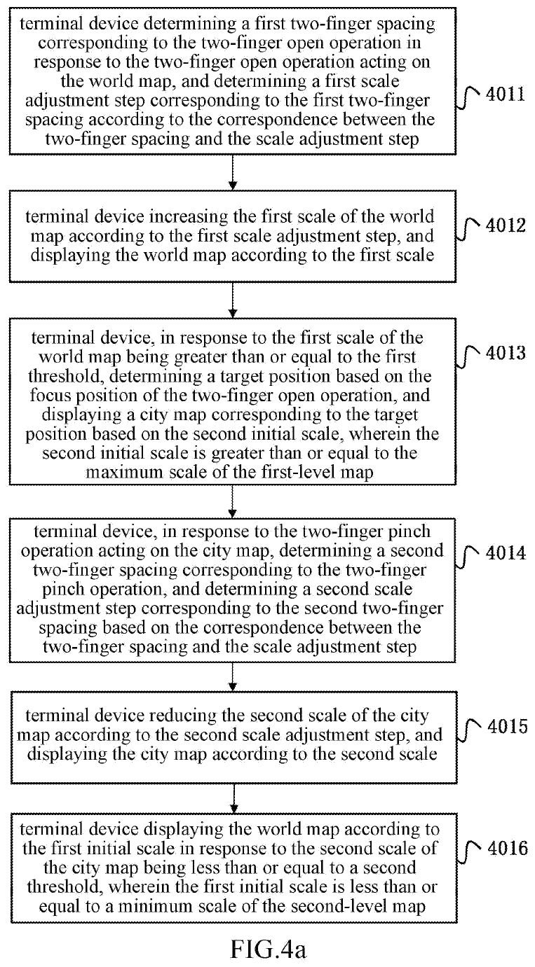

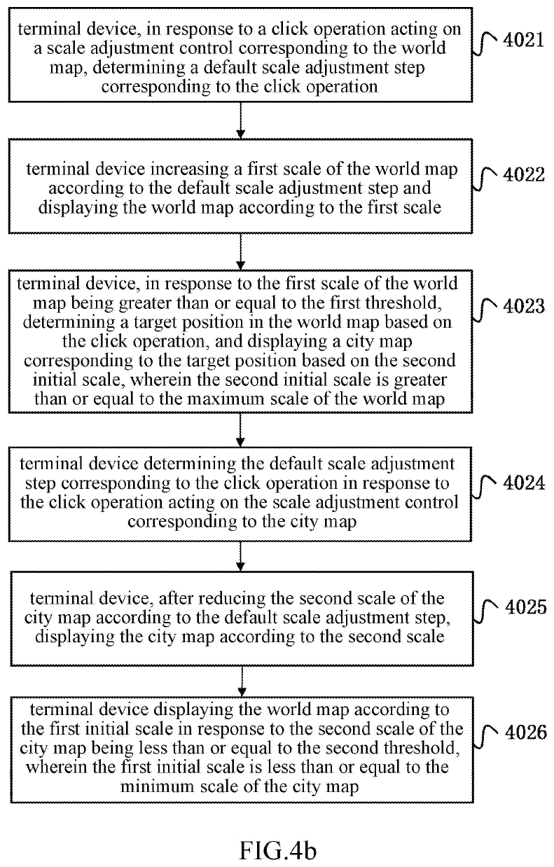

Referring to FIG. 4a, the specific process of a map display control method provided by an embodiment of the present disclosure is as follows.

Step 4011, the terminal device determines a first two-finger spacing corresponding to the two-finger open operation in response to the two-finger open operation acting on the world map, and determines a first scale adjustment step corresponding to the first two-finger spacing according to the correspondence between the two-finger spacing and the scale adjustment step.

Step 4012, the terminal device increases the first scale of the world map according to the first scale adjustment step, and displays the world map according to the first scale.

Step 4013, the terminal device, in response to the first scale of the world map being greater than or equal to the first threshold, determines a target position based on the focus position of the two-finger open operation, and displays a city map corresponding to the target position based on the second initial scale, wherein the second initial scale is greater than or equal to the maximum scale of the first-level map.

Optionally, the terminal device may determine the focus position of the two-finger open operation as the target position directly, or may determine a position within a set range of the focus position of the two-finger open operation that satisfies the condition as the target position, which is not specifically limited herein.

Step 4014, the terminal device, in response to the two-finger pinch operation acting on the city map, determines a second two-finger spacing corresponding to the two-finger pinch operation, and determines a second scale adjustment step corresponding to the second two-finger spacing based on the correspondence between the two-finger spacing and the scale adjustment step.

Step 4015, the terminal device reduces the second scale of the city map according to the second scale adjustment step, and displays the city map according to the second scale.

Step 4016, the terminal device displays the world map according to the first initial scale in response to the second scale of the city map being less than or equal to a second threshold, wherein the first initial scale is less than or equal to a minimum scale of the second-level map.

Referring to FIG. 4b, a map display control method provided by another embodiment of the present disclosure is shown in the following specific process.

Step 4021, the terminal device, in response to a click operation acting on a scale adjustment control corresponding to the world map, determines a default scale adjustment step corresponding to the click operation.

Step 4022, the terminal device increases a first scale of the world map according to the default scale adjustment step and displays the world map according to the first scale.

Step 4023, the terminal device, in response to the first scale of the world map being greater than or equal to the first threshold, determines a target position in the world map based on the click operation, and displays a city map corresponding to the target position based on the second initial scale, wherein the second initial scale is greater than or equal to the maximum scale of the world map.

Optionally, the terminal device may determine the target position based on the position where the click operation is performed, or may also determine the target position based on the selection operation acting on the world map prior to the click operation, which is not specifically limited herein.

Step 4024, the terminal device determines the default scale adjustment step corresponding to the click operation in response to the click operation acting on the scale adjustment control corresponding to the city map.

Step 4025, the terminal device, after reducing the second scale of the city map according to the default scale adjustment step, displays the city map according to the second scale.

Step 4026, the terminal device displays the world map according to the first initial scale in response to the second scale of the city map being less than or equal to the second threshold, wherein the first initial scale is less than or equal to the minimum scale of the city map.

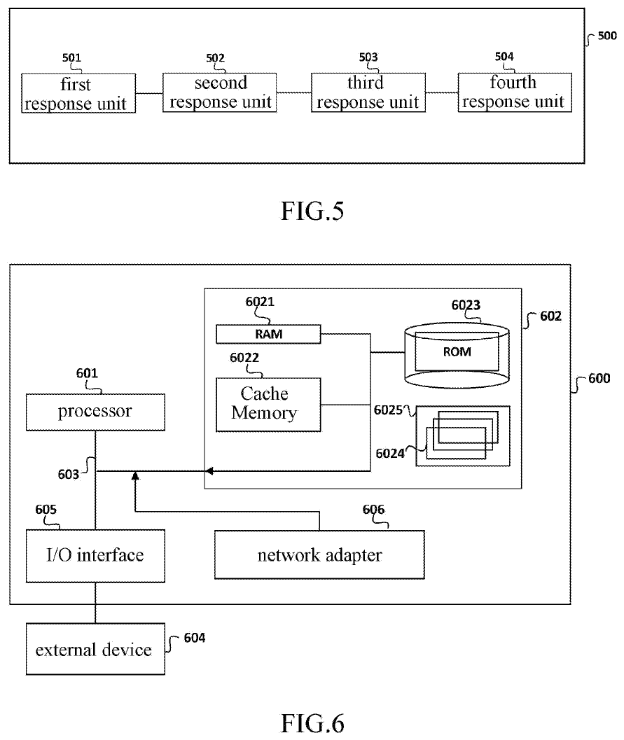

Based on the above embodiments, the present disclosure embodiment provides a map display control apparatus. Referring to FIG. 5, the map display control apparatus 500 provided by embodiments of the present disclosure at least includes:

a first response unit 501, configured to increase a first scale of a first-level map in response to a map enlargement instruction for the first-level map, and display the first-level map according to the first scale; and

a second response unit 502, configured to determine a target position in the first-level map according to the map enlargement instruction in response to the first scale being greater than or equal to a first threshold, and display a second-level map corresponding to the target position.

In one possible implementation, the first-level map is a map corresponding to a first region, the second-level map is a map corresponding to a second region, the first region includes the second region, and the second region includes the target position.

In one possible implementation, when the second-level map corresponding to the target position is displayed, the second response unit 502 is specifically configured to:
display the second-level map corresponding to the target position in a second initial scale.

In one possible implementation, the second initial scale is greater than or equal to a maximum scale of the first-level map.

In one possible implementation, the target position is a focus position of the map enlargement instruction, or the target position is a position within a set range of the focus position of the map enlargement instruction that satisfies a condition.

In one possible implementation, the first-level map and the second-level map are two preset maps.

In one possible implementation, the map display control apparatus 500 provided by an embodiment of the present disclosure further includes:
a third response unit 503, configured to reduce a second scale of the second-level map in response to a map reduction instruction for the second-level map, and display the second-level map according to the second scale;
a fourth response unit 504, configured to display the first-level map in response to the second scale being less than or equal to a second threshold.

In one possible implementation, the map enlargement instruction is a two-finger open operation acting on the first-level map, and the map reduction instruction is a two-finger pinch operation acting on the second-level map.

In one possible implementation, when the first-level map is displayed, the fourth response unit 504 is specifically configured to:
display the first-level map in a first initial scale.

In one possible implementation, the first initial scale is less than or equal to a minimum scale of the second-level map.

It should be noted that the principles of the map display control apparatus 500 provided by embodiments of the present disclosure to solve technical problems are similar to those of the map display control method provided by embodiments of the present disclosure. Therefore, the implementation of the map display control apparatus 500 provided by embodiments of the present disclosure can be referred to the implementation of the map display control method provided by embodiments of the present disclosure, and the repetition will not be repeated.

Having described the map display control method and apparatus provided by embodiments of the present disclosure, the terminal device provided by embodiments of the present disclosure is briefly described next.

Referring to FIG. 6, the terminal device 600 provided by embodiments of the present disclosure includes at least: a processor 601, a memory 602 and computer programs stored on the memory 602 and executable on the processor 601. The processor 601 implements the map display control method provided by embodiments of the present disclosure when executing the computer programs.

The terminal device 600 provided by embodiments of the present disclosure may also include a bus 603 connecting different components, including the processor 601 and the memory 602. The bus 603 represents one or more of several types of bus structures, including a memory bus, a peripheral bus, a local area bus, and the like.

The memory 602 may include readable media in the form of volatile memory, such as Random Access Memory (RAM) 6021 and/or Cache Memory 6022, and may further include Read Only Memory (ROM) 6023.

The memory 602 may also include a program tool 6025 having a set (at least one) of program modules 6024, the program modules 6024 including, but not limited to: an operating subsystem, one or more applications, other program modules, and program data. Each of these examples or some combination may include an implementation of a network environment.

The terminal device 600 may also communicate with one or more external devices 604 (e.g., keyboard, remote control, etc.), may also communicate with one or more devices that enable the user to interact with the terminal device 600 (e.g., mobile phone, computer, etc.), and/or, may communicate with any device that enables the terminal device 600 to communicate with one or more other terminal devices 600 (e.g., router, modem, etc.). This communication may be via Input/Output (I/O) interface 605. Besides, the terminal device 600 may communicate with one or more networks (e.g., Local Area Network (LAN), Wide Area Network (WAN), and/or public networks, such as the Internet) via the network adapter 606. As shown in FIG. 6, the network adapter 606 communicates with other modules of the terminal device 600 via the bus 603. It should be understood that, although not shown in FIG. 6, other hardware and/or software modules may be used in conjunction with the terminal device 600, including but not limited to: microcode, device drives, redundant processors, external disk drive arrays, Redundant Arrays of Independent Disks (RAID) subsystems, tape drives, and data backup storage subsystems, etc.

It should be noted that the terminal device 600 shown in FIG. 6 is merely an example and does not constitute a limitation of the terminal device 600. The terminal device may include more or fewer components than shown.

The computer readable storage medium provided by embodiments of the present disclosure is described below. The computer readable storage medium provided by embodiments of the present disclosure stores computer instructions that, when executed by a processor, implement the map display control method provided by embodiments of the present disclosure. Specifically, the computer instructions may be built into or installed in the terminal device 600, such that the terminal device 600 can implement the map display control method provided by embodiments of the present disclosure by executing the built-in or installed computer instructions.

In addition, the map display control method provided by embodiments of the present disclosure can also be implemented as a program product, which includes a program code for causing the terminal device 600 execute the map display control method provided by embodiments of the present disclosure when the program product is run on the terminal device 600.

The program product provided by embodiments of the present disclosure can adopt any combination of one or more readable media. The readable media can be a readable signal medium or a readable storage medium. The readable storage medium can be, but not limited to, an electrical, magnetic, optical, electromagnetic, infrared, or semiconductor system, apparatus or device, or any combination of the above. Specifically, more specific examples (a non-exhaustive list) of readable storage media include: an electrical connection with one or more wires, a portable disk, a hard disk, a RAM, a ROM, an erasable programmable read only memory (EPROM), an optical fiber, a portable Compact Disc Read-Only Memory (CD-ROM), an optical storage device, a magnetic storage device, or any combination thereof.

The program product provided by embodiments of the present disclosure can adopt CD-ROM and include program codes, and can also be run on a computing device. However, the program products provided by the embodiments of this disclosure are not limited to this. In the embodiments of this disclosure, the readable storage medium can be any tangible medium containing or storing a program, which can be used by or in combination with an instruction execution system, apparatus or device.

It should be noted that although several units or sub-units of the apparatus are mentioned in the above detailed description, this division is only exemplary and not mandatory. Actually, according to the embodiment of the present disclosure, the features and functions of two or more units described above can be embodied in one unit. On the contrary, the features and functions of one unit described above can be further divided into a plurality of units to be embodied.

Furthermore, although the operations of the disclosed method are described in a specific order in the drawings, this does not require or imply that these operations must be performed in this specific order, or that all the illustrated operations must be performed to achieve the desired results. Additionally or alternatively, some steps may be omitted, a plurality of steps may be combined into one step for execution, and/or one step may be decomposed into a plurality of steps for execution.

Although the preferred embodiments of the present disclosure have been described, those skilled in the art can make additional changes and modifications to these embodiments once they know the basic inventive concepts. Therefore, the appended claims are intended to be interpreted as including the preferred embodiments and all changes and modifications that fall within the scope of this disclosure.

Those skilled in the art can make various modifications and variations to the disclosed embodiments without departing from the spirit and scope of the disclosed embodiments. Thus, if these modifications and variations of the embodiments of this disclosure are within the scope of the claims of this disclosure and their equivalents, this disclosure is also intended to include these modifications and variations.

1. A map display control method, comprising
increasing a first scale of a first-level map in response to a map enlargement instruction for the first-level map, and displaying the first-level map according to the first scale; and
determining a target position in the first-level map according to the map enlargement instruction in response to the first scale being greater than or equal to a first threshold, and displaying a second-level map corresponding to the target position.

2. The map display control method according to claim 1, wherein the first-level map is a map corresponding to a first region, the second-level map is a map corresponding to a second region, the first region comprises the second region, and the second region comprises the target position.

3. The map display control method according to claim 1, wherein displaying the second-level map corresponding to the target position comprises:
displaying the second-level map corresponding to the target position in a second initial scale.

4. The map display control method according to claim 3, wherein the second initial scale is greater than or equal to a maximum scale of the first-level map.

5. The map display control method according to claim 1, wherein the target position is a focus position of the map enlargement instruction.

6. The map display control method according to claim 1, wherein the first-level map and the second-level map are two preset maps.

7. The map display control method according to claim 1, further comprising:
reducing a second scale of the second-level map in response to a map reduction instruction for the second-level map, and displaying the second-level map according to the second scale;
displaying the first-level map in response to the second scale being less than or equal to a second threshold.

8. The map display control method according to claim 7, wherein the map enlargement instruction is a two-finger open operation acting on the first-level map, and the map reduction instruction is a two-finger pinch operation acting on the second-level map.

9. The map display control method according to claim 7, wherein displaying the first-level map comprises:
displaying the first-level map in a first initial scale.

10. The map display control method according to claim 9, wherein the first initial scale is less than or equal to a minimum scale of the second-level map.

11. A map display control apparatus, comprising:
a memory, a processor and computer programs stored on the memory and executable on the processor,
wherein when executing the computer programs, the processor is configured to:
increase a first scale of a first-level map in response to a map enlargement instruction for the first-level map, and display the first-level map according to the first scale; and
determine a target position in the first-level map according to the map enlargement instruction in response to the first scale being greater than or equal to a first threshold, and display a second-level map corresponding to the target position.

12. (canceled)

13. A non-transitory computer readable storage medium, having computer instructions stored thereon, wherein the computer instructions implement a map display control method when executed by a processor, the method comprising:
increasing a first scale of a first-level map in response to a map enlargement instruction for the first-level map, and displaying the first-level map according to the first scale; and
determining a target position in the first-level map according to the map enlargement instruction in response to the first scale being greater than or equal to a first threshold, and displaying a second-level map corresponding to the target position.

14. The map display control method according to claim 1, wherein the target position is a position within a set range of the focus position of the map enlargement instruction that satisfies a condition.

15. The map display control apparatus according to claim 11, wherein the first-level map is a map corresponding to a first region, the second-level map is a map corresponding to a second region, the first region comprises the second region, and the second region comprises the target position.

16. The map display control apparatus according to claim 11, wherein the processor is further configured to:
display the second-level map corresponding to the target position in a second initial scale.

17. The map display control apparatus according to claim 16, wherein the second initial scale is greater than or equal to a maximum scale of the first-level map.

18. The map display control apparatus according to claim 11, wherein the target position is a focus position of the map enlargement instruction.

19. The map display control apparatus according to claim 11, wherein the target position is a position within a set range of the focus position of the map enlargement instruction that satisfies a condition.

20. The map display control apparatus according to claim 11, wherein the first-level map and the second-level map are two preset maps.

21. The map display control apparatus according to claim 11, wherein the processor is further configured to:
reduce a second scale of the second-level map in response to a map reduction instruction for the second-level map, and display the second-level map according to the second scale;
display the first-level map in response to the second scale being less than or equal to a second threshold.
